(19) United States
(12) Patent Application Publication
(10) Pub. No.: US 2022/0124983 A1
(43) Pub. Date: Apr. 28, 2022

(54) COMBINE HARVESTER HAVING AN ADJUSTABLE STRATIFICATION PAN, AND RELATED METHODS

(71) Applicant: AGCO International GmbH, Neuhausen (CH)

(72) Inventor: Andreas Rye Andersen, Randers (US)

(21) Appl. No.: 17/452,738

(22) Filed: Oct. 28, 2021

(30) Foreign Application Priority Data
Oct. 27, 2020 (GB) 2016997.5

(51) Int. Cl. A01F 12/30; A01F 12/18; A01D 41/127

(52) U.S. Cl. CPC A01F 12/30; A01D 41/127; A01F 12/184

(57) ABSTRACT

A combine harvester includes a feederhouse configured to convey a crop material from a harvesting header, a threshing system configured to receive the crop material from the feederhouse and separate straw therefrom, and a cleaning system below the threshing system and configured to separate grain from chaff of the crop material. The cleaning system includes a stratification pan, a chaffer, and a blower to direct air rearward and upward through the chaffer. The stratification pan has a frame, a series of adjustable ripple members coupled to the frame, a series of support members pivotally coupled to the frame, and an adjusting rod configured to move the support members to change an incline angle of the ripple members relative to the frame. Each support member also supports one of the ripple members. Related methods are also disclosed.

### FIELD

Embodiments of the present disclosure relate to combine harvesters. More particularly, embodiments of the present disclosure relate to apparatuses and methods for controlling crop material flow through a separation system.

### BACKGROUND

Self-propelled combine harvesters are used by farmers to harvest a wide range of crops. Typically, a combine harvester cuts crop material, threshes grain therefrom, separates the threshed grain from the straw, and cleans the grain before storage in an onboard tank. Straw and crop residue is ejected from the rear of the combine harvester in the field.

Combine harvesters may have one or more threshing cylinders that rotate on axes parallel to a direction of travel of the combine harvesters and thresh the cut crop material. Grain and chaff separated in this process falls due to gravity through a grate onto an underlying thresher pan, which is driven in an oscillating manner to convey the grain and chaff rearward to a rear edge, where the grain and chaff falls into a cleaning unit. The straw by-product is ejected from the rear of the combine.

The cleaning unit of most combines operates according to a well-established process in which grain and chaff (also referred to in the art as material other than grain (MOG)) cascading down from the thresher and separator pans is subjected to an airstream created by one or more fans. A chaffer has a frame that supports a series of louvers, which are positioned to allow grain to fall downward through the chaffer while allowing a flow of cleaning air to pass upward and rearward through the chaffer. The cleaning air flow tends to force MOG rearward and restricts MOG from falling through the chaffer. The heavier grain falls through the chaffer and optionally through another cleaning sieve below before being conveyed to the grain tank.

The speed of the airflow through the chaffer may be selected to balance various operational parameters for agronomic benefit, such as percentage of chaff removed from the crop material, percentage of grain lost from the rear of the machine, mass throughput, and fuel usage.

Cleaning units in combine harvesters are described in more detail in, for example, U.S. Pat. No. 9,426,943, “Combine Harvester Grain Cleaning Apparatus,” issued Aug. 30, 2016; U.S. Patent Application Publication 2014/0128133, “Harvester Having Chaffer with Tiltable Section,” published May 8, 2014; and U.S. Pat. No. 5,624,315, “Cleaning Means for an Agricultural Harvesting Machine,” issued Apr. 29, 1997.

### BRIEF SUMMARY

A combine harvester includes a feederhouse that conveys a crop material from a harvesting header, a threshing system that receives the crop material from the feederhouse and separates straw therefrom, and a cleaning system below the threshing system that separates grain from chaff of the crop material. The cleaning system includes a stratification pan that receives crop material from the threshing system, a chaffer to receive the crop material from the stratification pan, and a blower to direct air rearward and upward through the chaffer. The stratification pan has a frame, a series of adjustable ripple members coupled to the frame, a series of support members pivotally coupled to the frame, and an adjusting rod configured to move the support members to change an incline angle of the ripple members relative to the frame. Each support member also supports one of the ripple members.

A method of operating a combine harvester includes cutting a crop in an agricultural field, threshing the crop in the threshing system, transferring the threshed first crop to the stratification pan, and separating the threshed crop into grain and chaff using the stratification pan, a chaffer, and a blower directing air rearward and upward through the chaffer. The stratification pan has a frame, a series of adjustable ripple members coupled to the frame, a series of support members pivotally coupled to the frame, and an adjusting rod configured to move the support members to change an incline angle of the ripple members relative to the frame. Additional crop is cut, threshed, and separated after the lever is moved to change the incline angle of the ripple members relative to the frame.

### BRIEF DESCRIPTION OF THE DRAWINGS

While the specification concludes with claims particularly pointing out and distinctly claiming what are regarded as embodiments of the present disclosure, various features and advantages of the disclosure may be more readily ascertained from the following description of example embodiments when read in conjunction with the accompanying drawings, in which:

FIG. 1 is a simplified side view of a combine harvester;

FIG. 2 is a simplified side view of a crop processing apparatus that may be used in the combine harvester of FIG. 1;

FIG. 3 is a simplified side view of a stratification pan that may be used in the crop processing apparatus of FIG. 2;

FIG. 4 is a simplified side view of the stratification pan of FIG. 3 in a different configuration;

FIG. 5 is a simplified perspective view of the stratification pan of FIG. 3;

FIG. 6 is a simplified side view of another stratification pan that may be used in the crop processing apparatus of FIG. 2;

FIG. 7 is a simplified side view of the stratification pan of FIG. 6 in a different configuration; and

FIG. 8 is a simplified flow chart illustrating a method of using a combine harvester to harvest crops in agricultural fields.

### DETAILED DESCRIPTION

The illustrations presented herein are not actual views of any combine harvester or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

From reading the following description it should be understood that the terms longitudinal and transverse are made in relation to the combine harvester's normal direction of travel. In other words, the term ‘longitudinal’ equates to the fore-and-aft direction, whereas the term ‘transverse’ equates to the crosswise direction, or left and right. Furthermore, the terms ‘axial’ and ‘radial’ are made in relation to a rotating body such as a shaft, wherein axial relates to a direction along the rotation axis and radial equates to a direction perpendicular to the rotation axis.

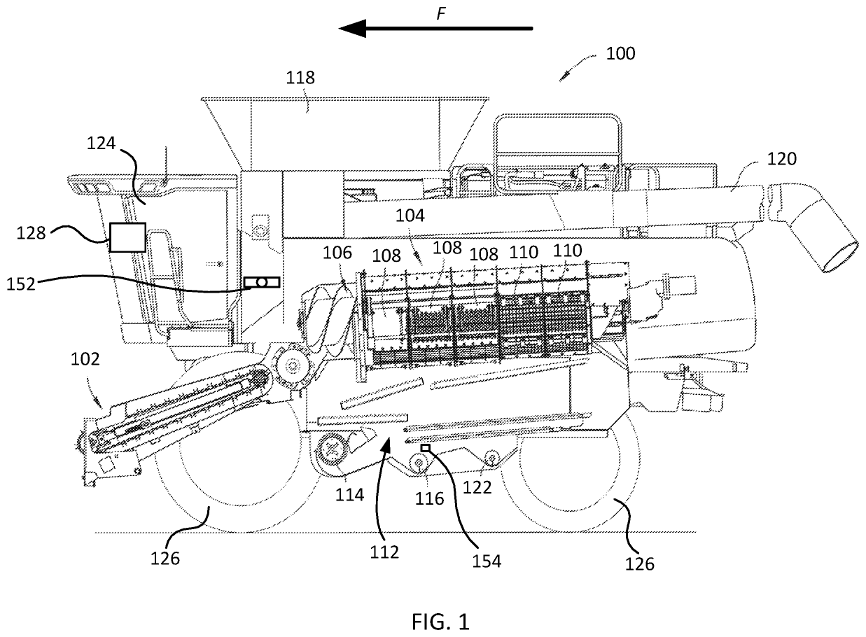

With reference to FIG. 1, a self-propelled combine harvester 100 is configured to carry a harvesting header that cuts and gathers a strip of crop as the combine harvester 100 is driven across a crop field in a forward direction F. A feederhouse 102 conveys the cut crop material from the harvesting header into a threshing system 104 in the combine harvester 100, in which the crop material is threshed and separated. The threshing system 104 may include, for example, an axial flow processing rotor 106 as described in U.S. Pat. No. 10,051,790, “Vane Arrangement in Combine Harvester Processor,” issued Aug. 21, 2018; a transverse flow rotor as described in U.S. Pat. No. 9,345,197, “Combine Harvester with Even Crop Distribution,” issued May 24, 2016; a hybrid system; or any other selected design.

The axial flow rotor 106 may generally move crop materials axially and helically rearward, threshing and separating grain from MOG. Concave assemblies 108 and separator grate assemblies 110 enable the grain to escape laterally and/or downward into a cleaning system 112 below. Bulkier stalk and leaf materials are retained by the concave assemblies 108 and the grate assemblies 110 and are impelled out the rear of the threshing system 104 and ultimately out the rear of the combine harvester 100.

The cleaning system 112 includes a blower 114 that can provide a stream of air through the cleaning system 112, which is directed out the rear of the combine harvester 100 to carry lighter chaff particles away from the grain as the grain migrates downward toward the bottom of the cleaning system 112 to a grain auger 116. The auger 116 delivers the clean grain to an elevator that carries the grain to a storage bin 118 on top of the machine, from which it is ultimately unloaded via an extendible unloading spout 120 (shown in a stowed position). A return auger 122 at the bottom of the cleaning system 112 may be used to recirculate partially threshed crop material into the front of the threshing system 104 for an additional pass through the threshing system 104.

The combine harvester 100 also typically includes an operator cab 124, an engine, and wheels 126 and/or tracks. In some embodiments, the combine harvester 100 may include a controller 128 (represented in FIG. 1 simply as a rectangular box), typically located in the operator cab 106, which the operator may use to control the combine harvester 100.

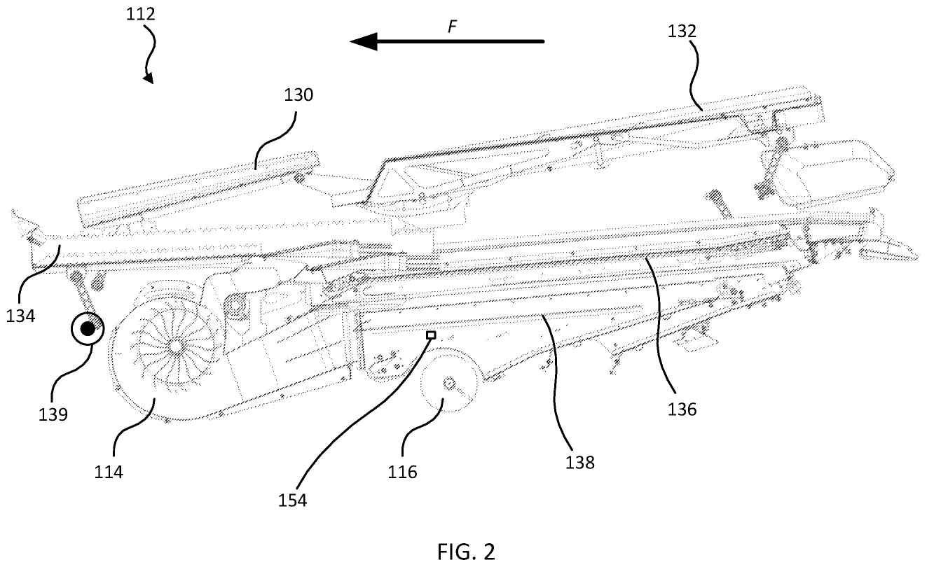

The cleaning system 112 is shown in more detail in FIG. 2. Crop material falls from the threshing system 104 onto a return pan 130 or a rear pan 132, depending on the position in the threshing system 104 from which the crop material falls. The return pan 130 may be sloped forward to direct crop material to a forward end of a stratification pan 134 located below the return pan 130.

The stratification pan 134, sometimes referred to as a ‘grain pan’, is impervious to crop material (unlike a sieve) and conveys the crop material rearward toward a chaffer 136 and a sieve 138. The stratification pan 134 is coupled to a motor 139 that shakes the stratification pan 134 to help separate the crop material. That is, less-dense material tends to move toward the top of the crop material, and more-dense material tends to move toward the bottom of the crop material. Thus, when the crop material reaches the chaffer 136, some separation has already begun. Air from the blower 114 blows through the chaffer 136 and sieve 138 and helps the chaffer 136 and sieve 138 separate grain from MOG. The initial separation on the stratification pan 134 may increase the ability of the chaffer 136 and sieve 138 to separate grain from MOG. The chaffer 136 and sieve 138 may operate as described in, for example, U.S. Pat. No. 9,426,943, “Combine Harvester Grain Cleaning Apparatus,” issued Aug. 30, 2016; and U.S. Pat. No. 5,624,315, “Cleaning Means for an Agricultural Harvesting Machine,” issued Apr. 29, 1997. The motor 139 that shakes the stratification pan 134 may also be coupled to the chaffer 136 and/or the sieve 138, such that the stratification pan 134 shakes at the same rate as the chaffer 136 and/or the sieve 138 (either in the same direction, in the opposite direction, or partially in the same direction (i.e., out of phase)). In other embodiments, the stratification pan 134 may shake independently of the chaffer 136 and sieve 138.

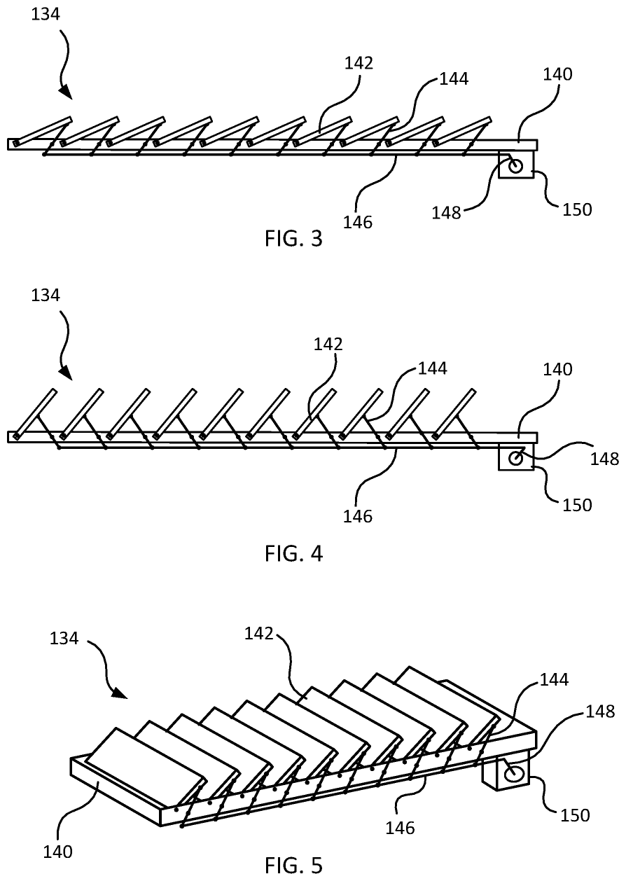

In certain conditions, changing the aggressiveness of the stratification pan 134 may improve performance of the cleaning system 112. FIGS. 3 and 4 illustrate an adjustment that may be made to the stratification pan 134. In particular, FIG. 3 illustrates the stratification pan 134 in a less aggressive configuration than in FIG. 4. A more aggressive configuration may be beneficial when the combine harvester 100 is traveling downhill or when the combine harvester 100 is harvesting crops with relatively large grain sizes (e.g., corn), and the less aggressive configuration may be beneficial when the combine harvester 100 is level or when the combine harvester 100 is harvesting crops with relatively small grain sizes (e.g., wheat). The stratification pan 134 may also be adjusted based on crop material flow, or any other parameter. Adjusting the stratification pan 134 may improve the separation of grain from chaff before the crop material reaches the chaffer 136, which may increase processing speed and separation quality of the cleaning system 112.

The stratification pan 134 has a frame 140 and a series of adjustable ripple members 142 pivotally coupled to the frame 140. Support members 144 are pivotally coupled to the frame 140, and each support member 144 supports one of the ripple members 142. An adjusting rod 146 may connect each of the support members 144 to a lever 148. Movement of the lever 148 pivots the support members 144 as shown in FIGS. 3 and 4. This pivoting motion changes the incline angle of the ripple members 142 relative to the frame 140 because the support members 144 are constrained to the frame 140 at pivot points, and the support members 144 may slide along the ripple members 142. The support members 144 may be coupled to the ripple members 142 such that vibration of the stratification pan 134 does not cause the ripple members 142 to bounce. That is, the connection between the support members 144 and the ripple members 142 may retain the ripple members 142 and prevent the ripple members 142 from moving except when the support members 144 move. The support members 144 may be secured to the ripple members 142 by any selected mechanism, for example, by one or more pins or rollers (e.g., protruding laterally from the support members 114) that slide or roll within tracks (e.g., defined in the ripple members 144). Thus, the orientation of each support member 144 together with the pivot point of the ripple members 142 fixes the orientation of the ripple members 142.

The ripple members 142 may each have a substantially planar upper surface, as illustrated in FIG. 5. The upper surfaces of each ripple member 142 may be generally parallel to one another because the support members 144 are coupled to the adjusting rod 146. The ripple members 142 may include a metal (e.g., steel), a polymer, or any other selected material. In some embodiments, the ripple members 142 may be injection molded plastic. In other embodiments, the ripple members 142 may be a steel substrate coated with a plastic covering.

An actuator 150 may be configured to move the lever 148 to change the orientation of the ripple members 142. For example, the actuator 150 may be a rotary actuator, a linear actuator, etc. The actuator 150 may be driven electrically, pneumatically, hydraulically, or by any other selected means. In other embodiments, the lever 148 may have a handle, and the lever 148 may be movable manually by an operator.

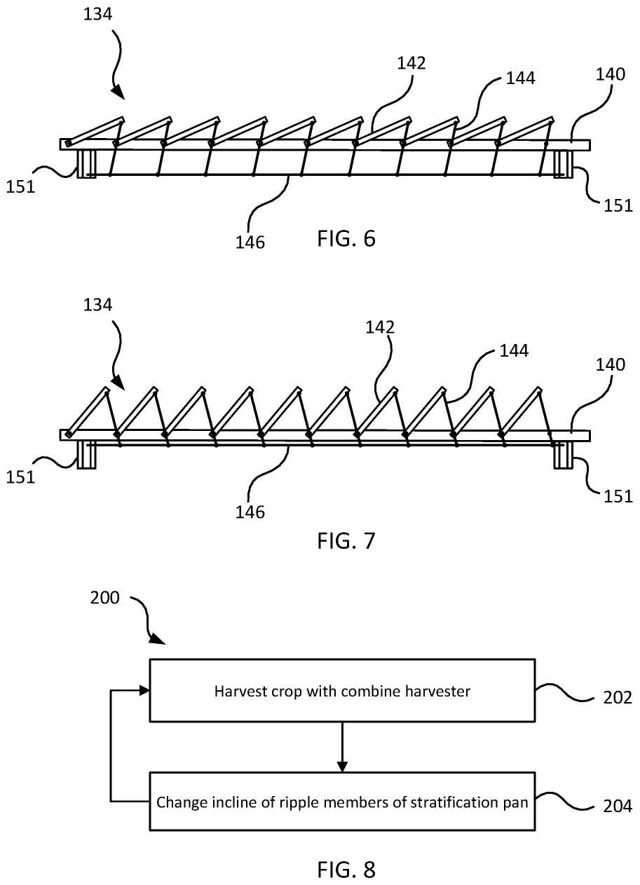

FIGS. 6 and 7 illustrate another mechanism by which the ripple members 142 may be adjusted. The support members 144 may be rotatably connected to the ripple members 142 at fixed points. The support members 144 may be configured to slide relative to the frame 140 by moving the adjusting rod 146 upward and downward. In some embodiments, the adjusting rod 146 may be coupled at one or both ends to a screw actuator 151 or another device to control the position of the ends of the adjusting rod 146 relative to the frame 140. Movement of the adjusting rod 146 changes the angle of the ripple members 142.

In some embodiments, the combine harvester 100 may have a sensor 152 (FIG. 1) configured to measure an orientation of the combine harvester 100. The sensor 152 is depicted conceptually as a single-axis bubble-level sensor, but any electrical or mechanical tilt sensor may be used. For example, the sensor 152 may be a two-axis MEMS inclinometer, an inertial sensor, a gyroscope, or any combination thereof. The controller 128 may be configured to send control signals to the actuator 150, and the control signals may be based at least in part on the measured orientation of the combine harvester 100.

For example, when the combine harvester 100 is on a downward slope, as detected by the sensor 152, the actuator 150 may move the ripple members 142 (by moving the lever 148, the adjusting rod 146, and the support members 144) to the position shown in FIG. 4. When the combine harvester 100 is on level ground, the actuator 150 may move the ripple members 142 to the position shown in FIG. 3. Other positions of the ripple members 142 may be selected to change the aggressiveness or separation characteristics of the stratification pan 134.

In other embodiments, a sensor 154 may be configured to measure another parameter of the combine harvester 100 or cleaning system 112. For example, the sensor 154 may be a flow sensor configured to measure air or solid material flow at a location within the cleaning system 112. The controller 128 (FIG. 1) may be configured to send control signals to the actuator 150 based at least in part on the parameter measured by the sensor 154.

Whether based on an orientation detected by the sensor 152 or another parameter measured by the sensor 154, the controller 128 may send control signals to the actuator 150 in real time while the combine harvester 100 travels through the field, based on actual conditions encountered. In some embodiments, the controller 128 may send control signals to the actuator 150 based on an expected crop yield. That is, the aggressiveness of the stratification pan 134 may be selected based on the crop variety planted, the seed population, irrigation history, sensed crop height, or any other data. The data used by the controller 128 may be collected by the combine harvester 100 or by any other device, either concurrently or prior to the harvest.

FIG. 8 is a simplified flow chart illustrating a method 200 of using the combine harvester 100 to harvest crops in an agricultural field. In block 202, a crop is harvested, such as by cutting with a harvesting header, threshing in the threshing system 104, and transferring crop to the stratification pan 134 and the chaffer 136 for separation.

As indicated in block 204, an incline of ripple members 142 of the stratification pan 134 can be changed, indicated by block 206. The harvest may then continue at block 202. The incline of the ripple members 142 may be changed with the actuator 150, and may be based on material flow in the combine harvester 100, expected or measured crop yield, orientation of the combine harvester 100, or any other parameter. The incline of the ripple members 142 may also be changed to harvest a different type of crop. The incline of the ripple members 142 may be changed manually or by the controller 128.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

What is claimed is:

1. A combine harvester comprising:
a feederhouse configured to convey a crop material from a harvesting header;
a threshing system configured to receive the crop material from the feederhouse and separate straw therefrom; and
a cleaning system below the threshing system and configured to separate grain from chaff of the crop material, the cleaning system comprising:
a stratification pan configured to receive the crop material from the threshing system; the stratification pan being impervious to the crop material and comprising:
a frame;
a series of adjustable ripple members pivotally coupled to the frame;
a series of support members coupled to the frame, wherein each of the support members supports at least one of the ripple members; and
an adjusting rod configured to move the support members to change an incline angle of the ripple members relative to the frame;
a chaffer configured to receive the crop material from the stratification pan; and
a blower configured to direct air rearward and upward through the chaffer.

2. The combine harvester of claim 1, wherein an orientation of each of the support members defines an orientation of one of the ripple members.

3. The combine harvester of claim 1, wherein each of the support members retains one of the ripple members.

4. The combine harvester of claim 1, wherein the ripple members each have a substantially planar upper surface.

5. The combine harvester of claim 1, further comprising a lever configured to move the adjusting rod.

6. The combine harvester of claim 1, further comprising an actuator configured to move the adjusting rod.

7. The combine harvester of claim 6, further comprising a controller configured to send a control signal to the actuator.

8. The combine harvester of claim 7, wherein the controller is operable from a cab of the combine harvester.

9. The combine harvester of claim 7, further comprising at least one sensor configured to measure an orientation of the combine harvester, and wherein the controller is configured to send the control signal to the actuator based at least in part on the orientation of the combine harvester.

10. The combine harvester of claim 1, further comprising a motor configured to oscillate the stratification pan.

11. The combine harvester of claim 1, wherein the threshing system comprises:
at least one threshing rotor configured to thresh the crop material and separate straw therefrom; and
at least one separator grate below the at least one threshing rotor.

12. The combine harvester of claim 1, further comprising a sieve below the chaffer.

13. A method of operating a combine harvester, the method comprising:
cutting crop in an agricultural field;
threshing the crop in a threshing system in the combine harvester;
transferring the threshed crop to a stratification pan in the combine harvester, the stratification pan being impervious to the crop material and comprising a frame, a series of adjustable ripple members pivotally coupled to the frame, a series of support members coupled to the frame, wherein each of the support members supports at least one of the ripple members, and an adjusting rod configured to move the support members;
separating the threshed crop into grain and chaff using the stratification pan, a chaffer, and a blower directing air rearward and upward through the chaffer;
moving the adjusting rod to change an incline angle of the ripple members relative to the frame;
cutting additional crop;
threshing the additional crop in the threshing system;
transferring the additional threshed crop to the stratification pan; and
separating the additional threshed crop into grain and chaff using the stratification pan, the chaffer, and the blower.

14. The method of claim 13, wherein moving the adjusting rod comprises moving the adjusting rod with an actuator.

15. The method of claim 14, wherein moving the adjusting rod with the actuator comprises controlling the actuator responsive to a measured material flow in the combine harvester.

16. The method of claim 14, wherein moving the adjusting rod with the actuator comprises controlling the actuator responsive to an expected crop yield.

17. The method of claim 14, wherein moving the adjusting rod with the actuator comprises controlling the actuator responsive to an orientation of the combine harvester.

18. The method of claim 13, wherein cutting the additional crop comprises cutting a different species than the crop.

19. The method of claim 13, wherein cutting the additional crop comprises cutting a same species as the crop, and wherein the additional crop is cut under different conditions than the crop.

20. The method of claim 13, wherein a mass flow rate of the additional crop across the stratification pan is different than a mass flow rate of the crop across the stratification pan.
